(19) United States
(12) Patent Application Publication
(10) Pub. No.: US 2023/0240929 A1
(43) Pub. Date: Aug. 3, 2023

(54) Inversion Table for Supporting Pulmonary Function

(71) Applicant: David Oppenheim, Erie, PA (US)

(72) Inventor: David Oppenheim, Erie, PA (US)

(21) Appl. No.: 18/161,071

(22) Filed: Jan. 29, 2023

Related U.S. Application Data
(60) Provisional application No. 63/304,300, filed on Jan. 28, 2022.

(51) Int. Cl. A61H 1/02

(52) U.S. Cl. CPC A61H 1/0229; A61H 2203/0493; A61H 2201/0138; A61H 2201/1616; A61H 2201/1642; A61H 2203/0456; A61H 2203/0468; A61H 2201/0192; A61H 2201/1607

(57) ABSTRACT

An inversion table comprises a tabletop that tilts upon a frame from up to a vertical orientation to up to 90° below horizontal. Shoulder supports are oriented and located such that the top of a user's shoulders rest against the shoulder supports and the user's body weight is borne by their shoulders when the tabletop is tilted below horizontal. Ankle supports hold the user on the inversion table as the tabletop tilts.

### BACKGROUND

Existing inversion tables support the user by the ankles while they lie in the supine position. When the table is inverted to a desired angle, the user is only supported by the ankles and experiences spinal traction under the force of gravity. Spinal traction is decompression of the vertebrae making up the spinal column and is commonly used for short term relief of back pain from compressed disks, pinched nerves, and other spinal conditions. However, traction on inversion tables constricts the chest wall and expansion of the lungs. There is currently nothing that supports pulmonary function by inverting a user as all known inversion tables are some version of traction devices.

### SUMMARY

What is presented is an inversion table comprising a tabletop that tilts upon a frame from up to a vertical orientation to up to 90° below horizontal. Shoulder supports are oriented and located such that the top of a user's shoulders rest against the shoulder supports and the user's body weight is borne by their shoulders when the tabletop is tilted below horizontal. Ankle supports hold the user on the inversion table as the tabletop tilts. The inversion table may bear a user supine or prone on the tabletop.

In some embodiments of the inversion table the ankle supports are loose. In other embodiments, the location of the ankle supports are adjustable along the length of the tabletop. In various embodiments, the location of said shoulder supports are adjustable along the length or the width of the tabletop.

Some embodiments of inversion table comprise a tabletop that tilts upon a frame from up to a vertical orientation to up to 90° below horizontal and shoulder supports. In these embodiments, ankle supports hold the user on the inversion table as the tabletop tilts, wherein the ankle supports are clamped against a user's ankles when the inversion table is used to place the user in traction or the ankle supports are unclamped against the user's ankle such that the shoulder supports bear the weight of the user's shoulders when the tabletop is tilted below horizontal. The inversion table may bear a user supine or prone on the tabletop.

In some embodiments of the inversion table the ankle supports are loose. In other embodiments, the location of the ankle supports are adjustable along the length of the tabletop. In various embodiments, the location of said shoulder supports are adjustable along the length or the width of the tabletop.

What is also presented is a method of treating a user to maintain and potentially improve pulmonary function or for pulmonary therapy to mobilize respiratory secretions. The method comprises first positioning the user in a prone or supine position on a tabletop, then positioning the user against shoulder supports that rest at the top of the user's shoulder, and finally tilting the tabletop such that a user's shoulders are below horizontal and the user's body weight is borne by their shoulders against the shoulder supports.

In some embodiments of the method, the users ankles are secured to the tabletop. In other embodiments, the tabletop is tilted such that a user's shoulders are up to 90° below horizontal.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF THE DRAWINGS

For a more complete understanding and appreciation of this invention, and its many advantages, reference will be made to the following detailed description taken in conjunction with the accompanying drawings.

FIG. 1 is a front perspective view of the inversion table in the upright position;

FIG. 2 is a rear perspective view of the inversion table in the upright position;

FIG. 3 is a detail view of the shoulder supports;

FIG. 4 is a perspective view of the inversion table tilted to 45 degrees from horizontal;

FIG. 5 is a perspective view of the inversion table tilted to 90 degrees from horizontal;

FIG. 6 is a rear perspective view of the inversion table tilted to 90 degrees from horizontal;

FIG. 7 is a view of a user laying supine on the inversion table in its upright position;

FIG. 8 is a view of a user laying supine on the inversion table in its inverted position;

FIG. 9 is a view of a user laying prone on the inversion table in its upright position; and

FIG. 10 is a front perspective view of another embodiment of the inversion table in the upright position.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

As we age, put on excess weight, or if we smoke, our respiratory function diminishes. The small airways (1 mm and smaller) in the lower lobes of our lungs don't expand and aerate, leading to retained secretions, infection, and scarring which lead to permanent reduction in pulmonary function. With our upright posture there is greater ventilation to the upper lobes of the lungs relative to the lower lobes. It takes greater effort and deep breaths to get the small airways in the lower lobes to expand and aerate. In an inverted state there would be greater ventilation of the lower lobe small airways since the warm air rises. An inverted state would also be beneficial for drainage of retained secretions due to gravity.

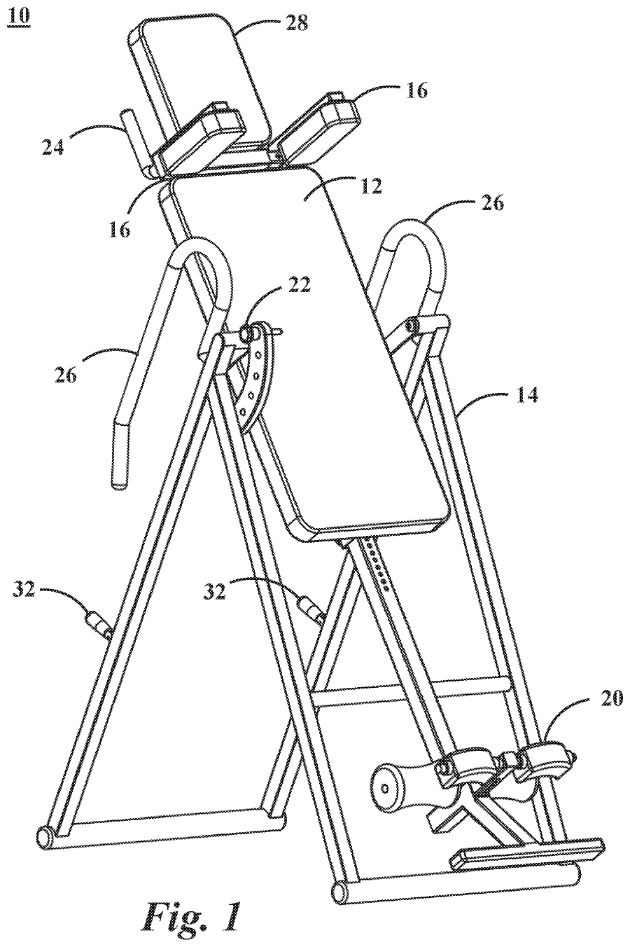

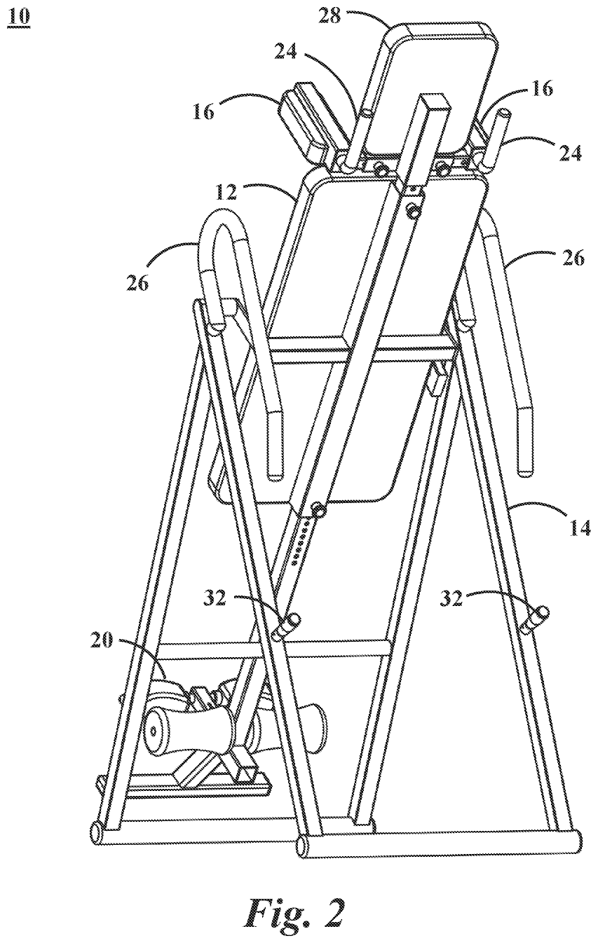

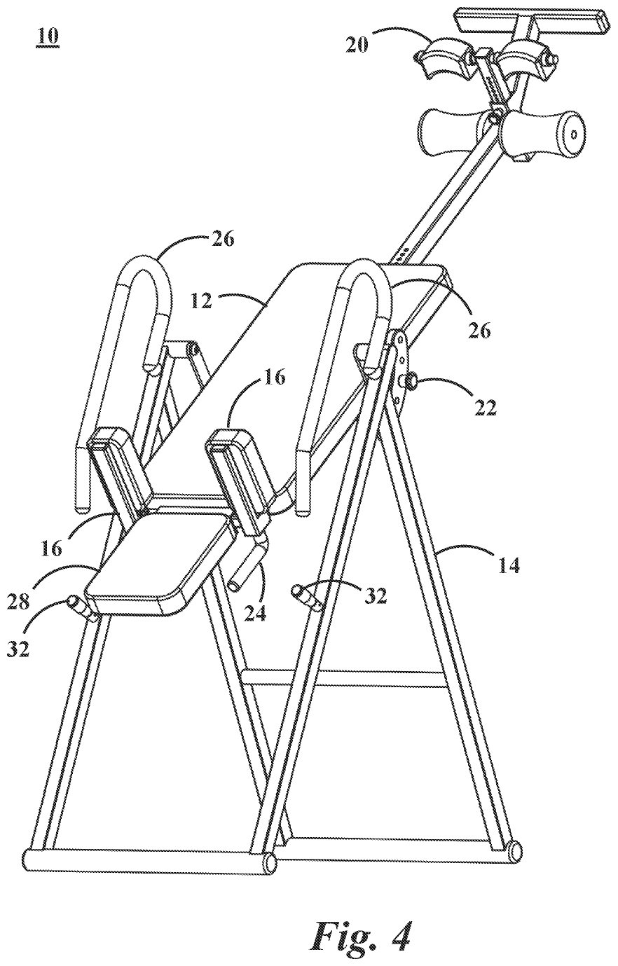

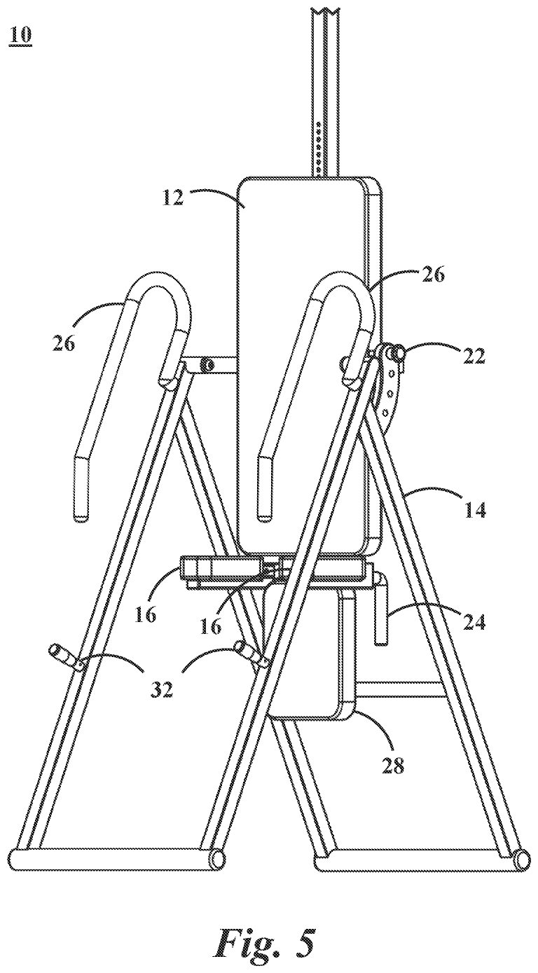

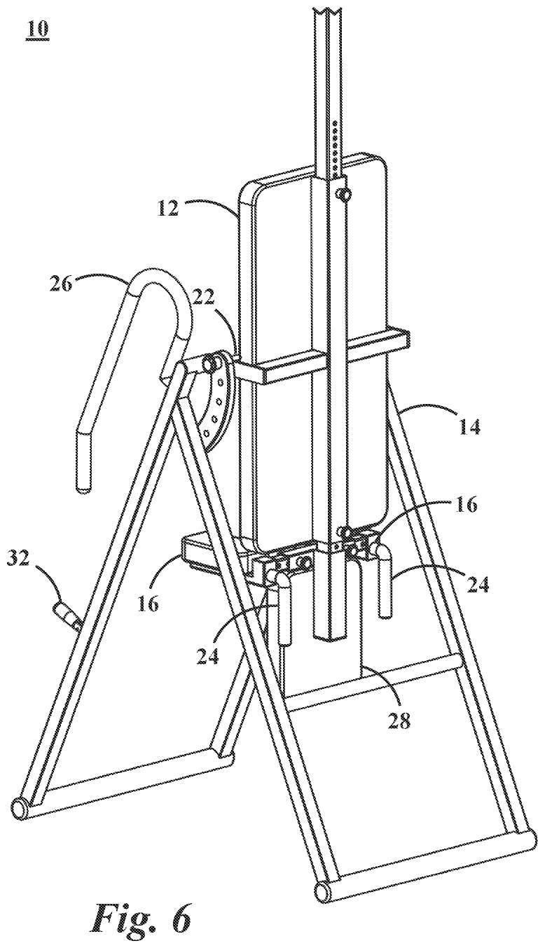

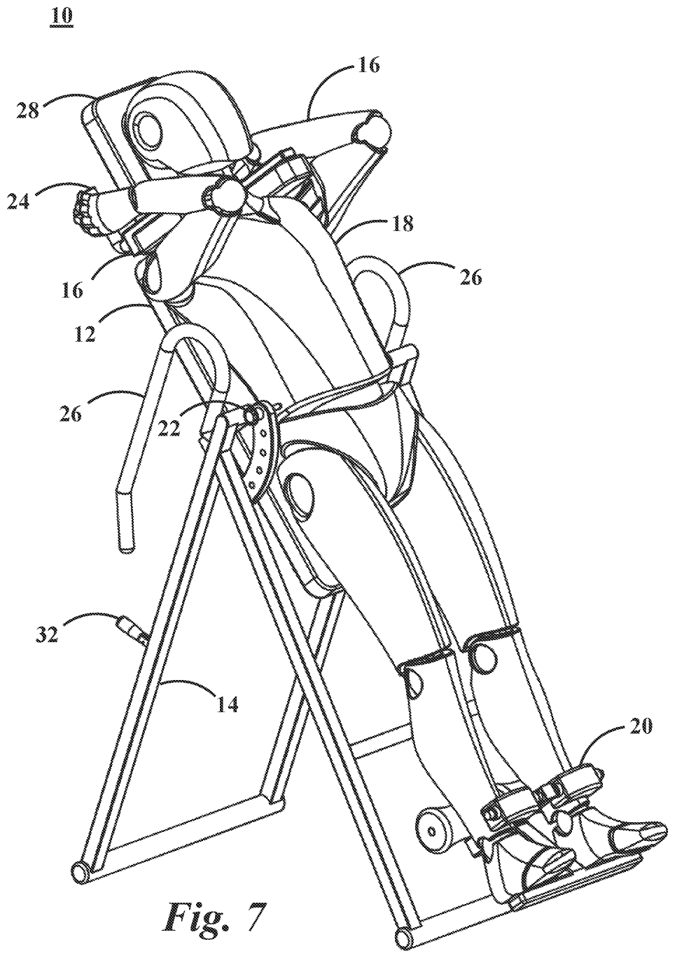

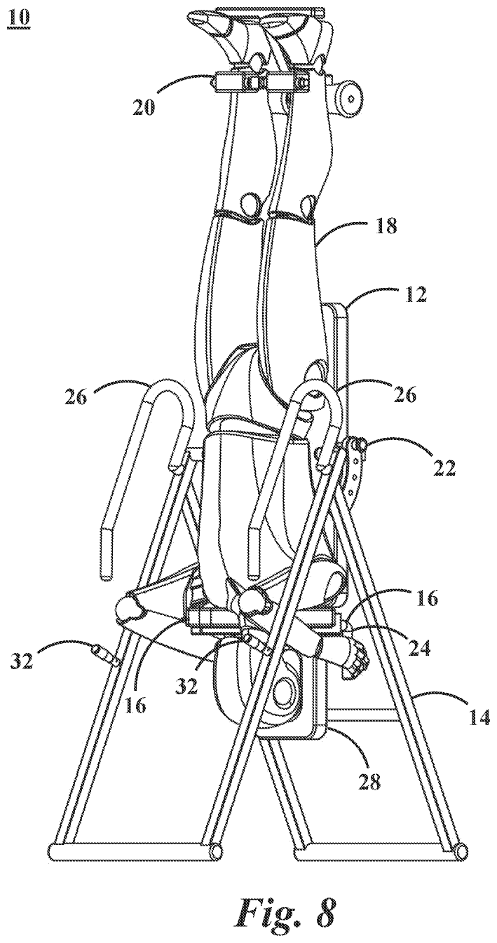

Current inversion tables are traction devices that are used to alleviate back pain. The user's weight is borne by a device that closes around the ankles. The traction is on the spine and rib cage. This impedes respiratory motion. As best understood by comparing FIGS. 1 through 6, what is presented in an inversion table 10 for improving pulmonary function. The inversion table 10 comprises a tabletop 12 that tilts upon a frame 14 from up to a vertical orientation to up to 90° below horizontal. As shown in FIG. 7, the tabletop 12 comprises shoulder supports 16 that are oriented and located such that the top of a user's 18 shoulders rest against the shoulder supports 16 and, shown in FIG. 8, the user's 18 body weight is borne by their shoulders when the tabletop 12 is tilted below horizontal. Ankle supports 20 are also provided for holding the user 18 on the inversion table 10 as the tabletop 12 tilts. The tabletop 12 in the embodiment shown in the figures includes a headpiece 28 to support a user's head.

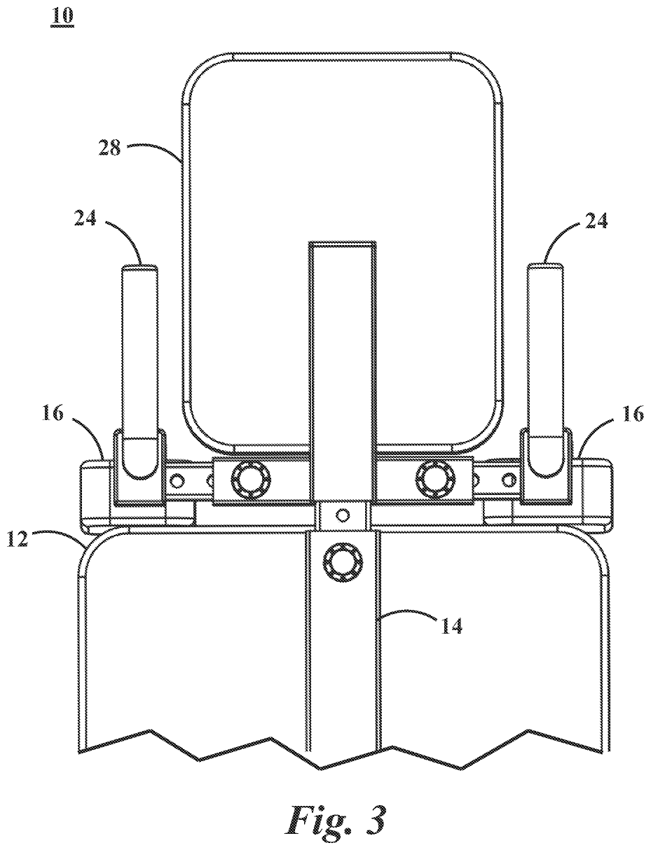

The tabletop 12 may be inverted upon the frame 14 to a desired angle which may be set with a pin 22. The shoulder supports 16 and the ankle supports 20 may be adjustable along the length and width of the tabletop 12 to accommodate users 18 of varying size. This adjustment could be done with fenestrated metal beams and a system of pins, bolts, or other means, as shown for example in FIG. 3. The shoulder supports 16 may include handles 24 for the user 18 to further support themselves while inverted on the inversion table 10. Additional handles 32 may be located on the frame 14 that would assist a user 18 to position the tabletop 12.

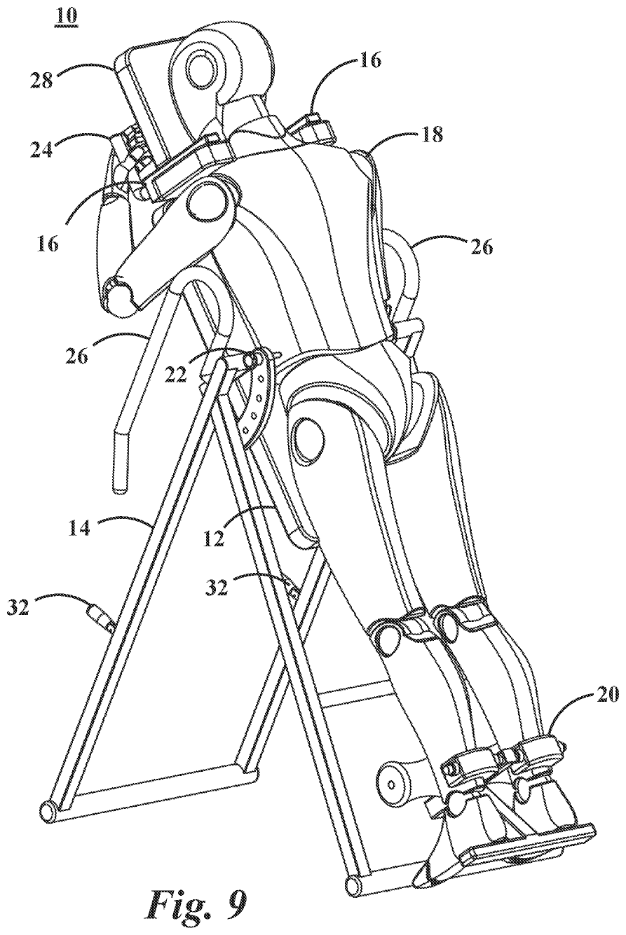

As shown in FIGS. 7 and 9, a user 18 may lie on the tabletop 12 in the prone or supine position according to their preference or comfort. As shown in the figures, a variety of handles 26, 32 may be included on the the frame 14 enable the user 18 to return to the upright position. The handles 26, 32 may be accessible in both the prone and supine position.

The ankle supports 20 are present to keep the user's 18 feet planted against the tabletop 12. In traction inversion tables, such ankle supports are intended to brace the user and put the user in traction when inverted. In contract, in the inversion table 10 disclosed herein, the ankle support 20 merely keeps the user 18 from slipping off the tabletop 12 and therefore the ankle supports only loosely hold the user's 18 ankles. However, the inversion table 10 may be converted from pulmonary support to a standard traction table by the removal of the shoulder supports 16 and the tightening the ankle supports 20 to bear the user's 18 weight.

Together, the shoulder support 16 and ankle support 20 fix the user's 18 torso on the tabletop 12 and prevent the user's 18 spinal column from going into traction when inverted. Preventing the user's 18 body from spinal traction prevents constriction of the chest wall, allowing the lungs to fully expand while inverted. Inversion without traction allows air to reach the lower lobes of the lungs, dears mucus from the bronchial tubes, and helps loosen and excrete retained secretions in the lungs that may result from scarring due to chronic airway disease and other pulmonary conditions. Inversion without traction also helps to mobilize kidney stones.

Any tilt below horizontal will provide a benefit but for more dramatic tilts below horizontal (between 45-degrees to 90-degrees below horizontal) generally daily use of no more than about 10 to 15 minutes is necessary. With less dramatic tilts below horizontal (between zero-degrees to 45-degrees below horizontal), a user may see be able to tolerate longer times on the table. Generally longer periods of time on the inversion table may be less comfortable for a user and it may be more beneficial to limit the user's time to shorter daily periods over an extended period of time rather than just a single long session.

The goal is to remove traction from the spine and rib cage and transfer the weight bearing to the shoulders. This would be accomplished with the padded adjustable shoulder supports 16. The tilt adjustment of the inversion table would be like that of standard traction inversion tables. The weight limit on most such tables is 250-300 lbs. The most expensive traction inversion table are all metal construction. Most of the rest have a padded wood platform bolted to the frame. With the weight redistribution suggested, a more robust frame attachment may be necessary. Standard inversion tables may be modified to include shoulder supports to bear the user's weight for the purpose of maintaining and improving lung function.

In addition, some hospital beds have features that will incline the bed in various angles. However, hospital beds do not incline at the range of an inversion table and do not include supports or features that would properly hold the patient on the bed.

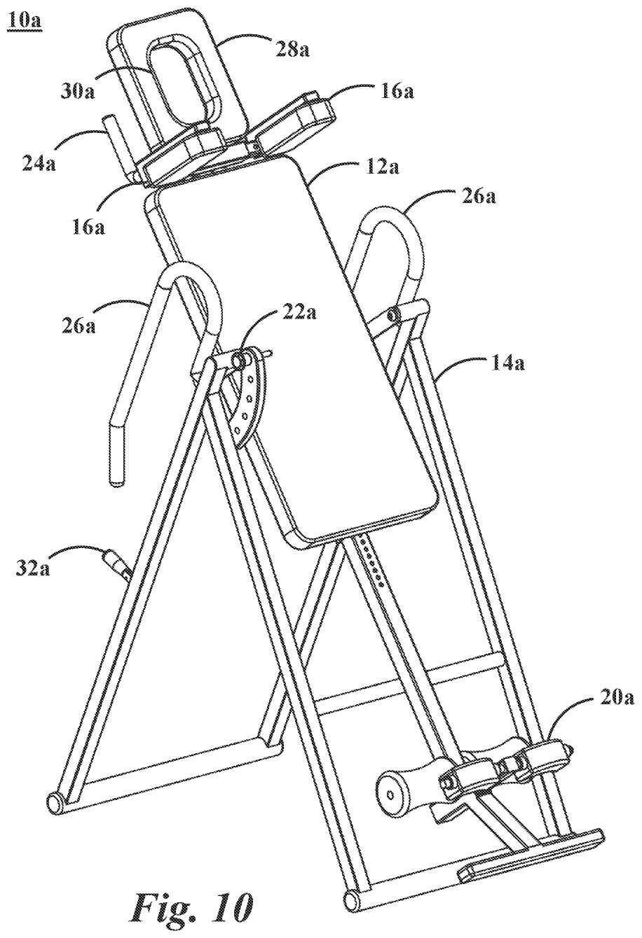

FIG. 10 shows another embodiment of inversion table 10a in which the headpiece 28a includes a hole 24a to accommodate the face of a user in the prone position. The hole 30a is such that a user's head is supported in either prone or supine position, but the hole allows greater comfort for a prone user.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. An inversion table comprising:
a tabletop that tilts upon a frame from up to a vertical orientation to up to 90° below horizontal;
shoulder supports are oriented and located such that the top of a user's shoulders rest against said shoulder supports and the user's body weight is borne by their shoulders when said tabletop is tilted below horizontal; and
ankle supports for holding the user on the inversion table as said tabletop tilts.

2. The inversion table of claim 1 wherein a user is supine or prone on the tabletop.

3. The inversion table of claim 1 further comprising said ankle supports are loose.

4. The inversion table of claim 1 further comprising the location of said ankle supports are adjustable along the length of said tabletop.

5. The inversion table of claim 1 further comprising the location of said shoulder supports are adjustable along the length of said tabletop.

6. The inversion table of claim 1 further comprising the location of said shoulder supports are adjustable along the width of said tabletop.

7. An inversion table comprising:
a tabletop that tilts upon a frame from up to a vertical orientation to up to 90° below horizontal;
shoulder supports;
ankle supports for holding the user on the inversion table as said tabletop tilts, wherein said ankle supports are clamped against a user's ankles when the inversion table is used to place the user in traction or said ankle supports are unclamped against the user's ankle such that said shoulder supports bear the weight of the user's shoulders when said tabletop is tilted below horizontal.

8. The inversion table of claim 7 wherein a user is supine or prone on the tabletop.

9. The inversion table of claim 7 further comprising the location of said ankle supports are adjustable along the length of said tabletop.

10. The inversion table of claim 7 further comprising the location of said shoulder supports are adjustable along the length of said tabletop.

11. The inversion table of claim 7 further comprising the location of said shoulder supports are adjustable along the width of said tabletop.

12. A method of treating a user to maintain pulmonary function or for pulmonary therapy to mobilize respiratory secretions, comprising:
positioning the user in a prone or supine position on a tabletop;
positioning the user against shoulder supports that rest at the top of the user's shoulder; and
tilting the tabletop such that a user's shoulders are below horizontal and the user's body weight is borne by their shoulders against the shoulder supports.

13. The method of claim 12 further comprising securing the users ankles to the tabletop.

14. The method of claim 12 further comprising tilting the tabletop such that a user's shoulders are up to 90° below horizontal.
